(19) United States
(12) Patent Application Publication
(10) Pub. No.: US 2026/0152210 A1
(43) Pub. Date: Jun. 4, 2026

(54) AUTONOMOUS VEHICLE AUTO-SUMMON AT CHECKOUT

(71) Applicant: TOSHIBA GLOBAL COMMERCE SOLUTIONS, INC., Durham, NC (US)

(72) Inventors: David J. STEINER, Durham, NC (US); Craig COMPTON, Wake Forest, NC (US); Daniel J. HUNT, Wake Forest, NC (US)

(21) Appl. No.: 18/969,129

(22) Filed: Dec. 4, 2024

(51) Int. Cl. B60W 60/00; G07G 1/00

(52) U.S. Cl. CPC B60W 60/00253; G07G 1/0009

(57) ABSTRACT

Embodiments herein use a checkout application to summon an autonomous vehicle of a customer who is performing a checkout process. In one embodiment, the checkout application identifies the stage that the customer is in in the checkout process such as arriving at a point-of-sale (POS) system, logging into a retailer application, scanning items, selecting a payment option, completing payment, loading purchased items in a cart/basket, etc. One of these stages can be selected as a “trigger stage” which, when reached by the customer, triggers the checkout application to summon the customer’s vehicle to a designated area (e.g., a lane near the store’s exit, special parking spots, etc.).

### BACKGROUND

After checking out, customers have to use a cart or carry their purchased items to their vehicle. Depending on how busy the retail store is (and how full the parking lot is), the customer may have parked far away from the store exit. Also, if the customer purchased many items (or heavy items), it may be difficult to push a cart (or carry) the items from the store exit to a vehicle. Also, the customer may be handicapped or have young children with them that makes traversing the parking lot difficult, especially with purchased items.

### BRIEF DESCRIPTION OF THE DRAWINGS

FIGS. 1A and 1B illustrate using a checkout application to auto-summon a customer’s autonomous vehicle, according to embodiments described herein.

FIG. 2 illustrates a system for auto-summoning a customer’s autonomous vehicle, according to embodiments described herein.

FIG. 3 is a flowchart for determining when to summon an autonomous vehicle for a customer performing a checkout process, according to embodiments described herein.

FIG. 4 is a flowchart for managing traffic flow when summoning an autonomous vehicle for a customer performing a checkout process, according to embodiments described herein.

### DETAILED DESCRIPTION

Embodiments herein use a checkout application to auto-summon an autonomous vehicle of a customer who is performing a checkout process. In one embodiment, the checkout application identifies the stage that the customer is in in the checkout process, such as arriving at a point-of-sale (POS) system, logging into a retailer application, scanning items, selecting a payment option, completing payment, loading purchased items in a cart/basket, etc. One of these stages can be selected as a “trigger stage” which, when reached by the customer, triggers the checkout application to summon the customer’s vehicle to a designated area (e.g., a lane near the store’s exit, special parking spots, etc.). The stage used to trigger auto-summoning the vehicle can vary depending on the distance from the user’s current location to the designated area, the amount of items the user purchased (which can affect how fast the customer or a cashier can load items into a cart or basket), the historical time it takes the customer to checkout, a queue at the exit of the store, and the like.

In one embodiment, the checkout application may also use one or more summoning thresholds to determine when to auto summon the vehicle. For example, if the user purchased a handful of items, this may be below a summoning threshold (which can be customizable by the customer). However, even if the user purchased a few items, if their weight or size (e.g., bulkiness) exceeds a summoning threshold, then the checkout application may summon the vehicle. The summoning thresholds can also adapt using information about the customers such as whether they are handicap, pregnant, and the like.

In another embodiment, the store may monitor the designated area used for the autonomous vehicles to pick up exiting users. If there are many customers using the auto-summoning service, the checkout application may display an estimated wait time to the customer. The customer can then select whether they would like to wait, or would prefer to just walk to their vehicle. Moreover, if there is a wait queue, the checkout application could give priority to customers who are handicap, pregnant, have small child with them, etc.

### Advantages of auto-summoning a vehicle using a checkout application

In addition to the convenience and safety issues that are resolved by the embodiments herein, there are technical advantages where the information learned by a checkout application can be leveraged with a vehicle communication network to summon autonomous vehicles. Without this channel of communication, an autonomous vehicle summoning system would have to use inferior data such as the customer’s location to decide when to move towards the exit of the store. Here, the checkout application can make a much more accurate decision when the customer will complete the checkout process and provide this prompt to the autonomous vehicle summoning system. In this manner, the embodiments herein can greatly improve autonomous vehicle summoning systems.

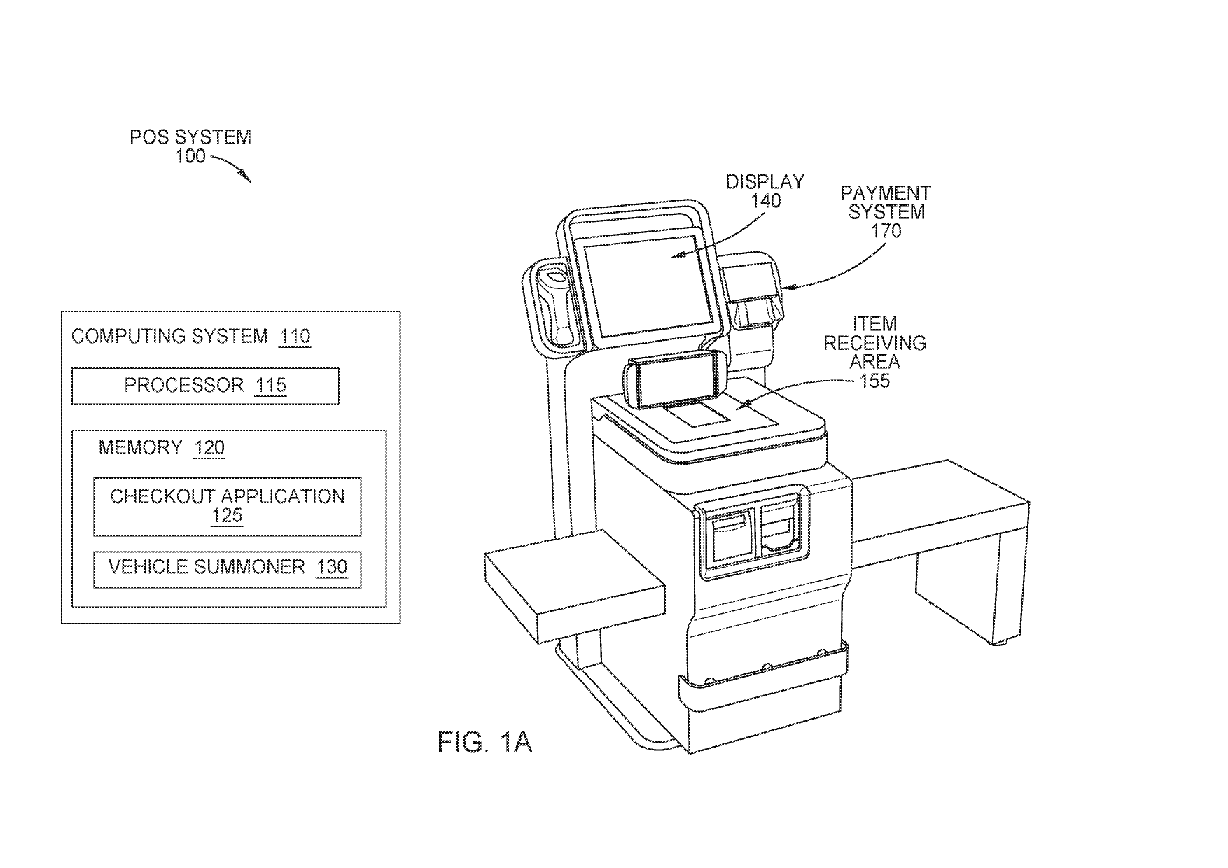

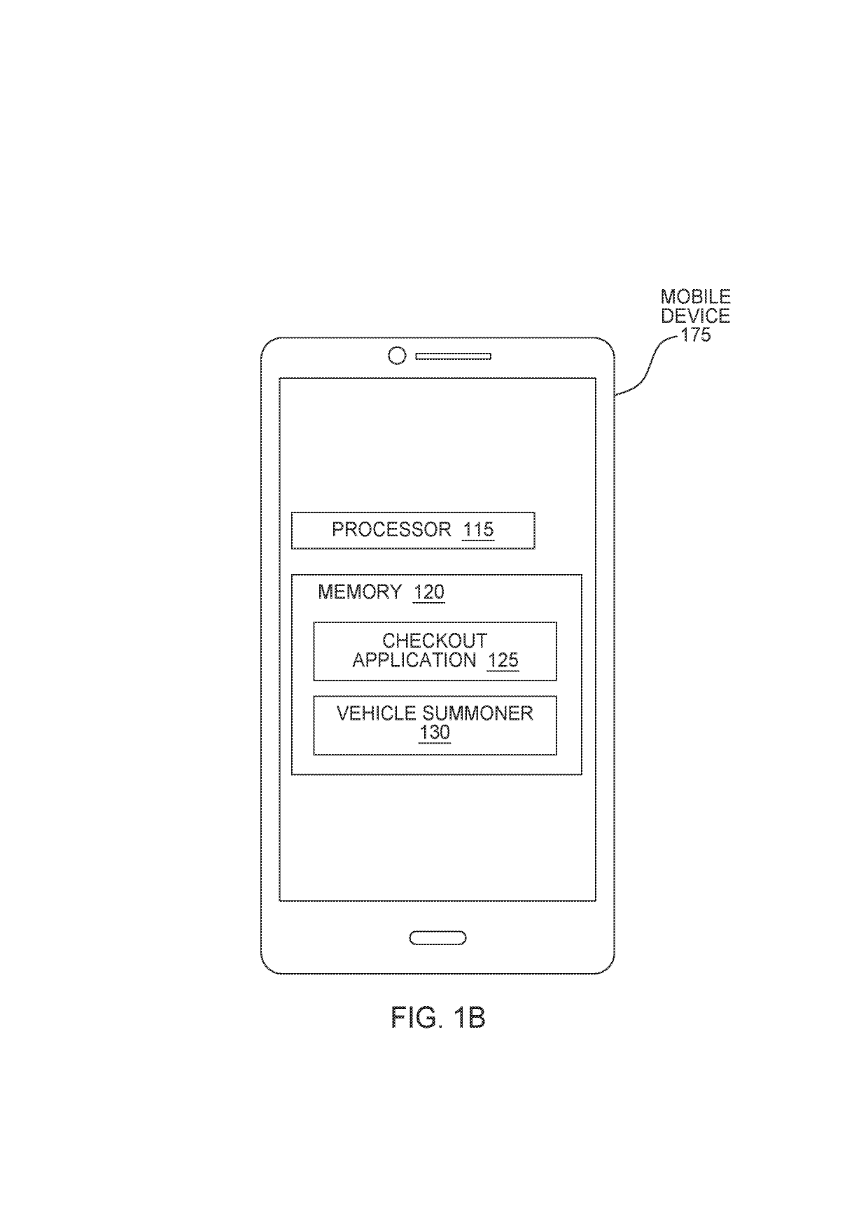

FIGS. 1A and 1B illustrate using a checkout application to auto-summon a customer’s autonomous vehicle, according to embodiments described herein. In FIG. 1A, the POS system 100 includes a computing system 110 with a processor 115 and memory 120. In one embodiment, the computing system 110 is an all-in-one (AIO) computer where each component of the computing system 110 is disposed within the POS system 100. The processor 115 can represent one or more processing elements, where each processing element can include one or more processing cores. The memory 120 can include volatile memory elements, non-volatile memory elements, and combinations thereof. Here, the memory stores a checkout application 125 (e.g., a software application) which can include an image recognition module that uses images captured by cameras to identify an item for purchase using a computer vision algorithm (e.g., an artificial intelligence (AI) or machine learning (ML) model), an item lookup module to identify items for purchase from scanning bar codes or radio frequency identification (RFID) tags, user interaction modules for displaying items for purchase and receiving user feedback, and the like.

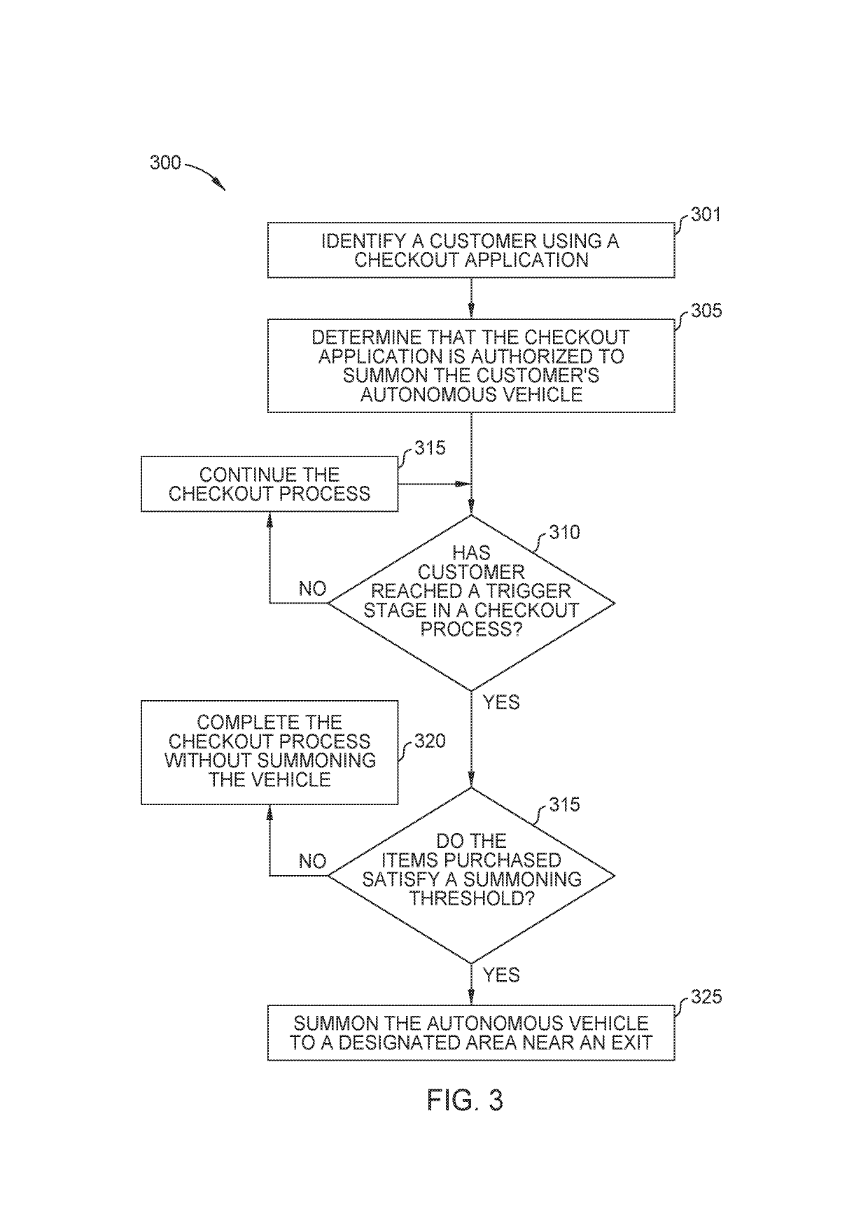

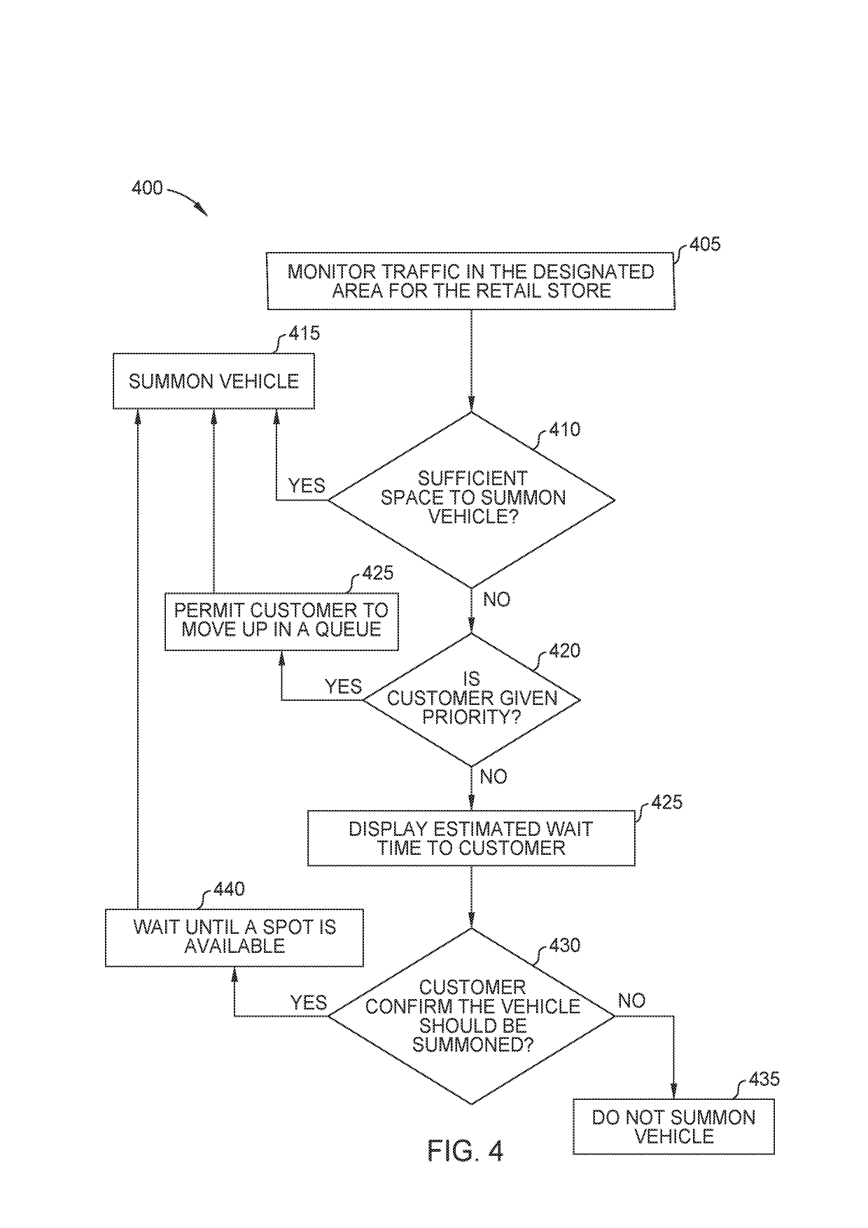

In addition to performing checkout functions, the checkout application can also determine when to auto-summon an autonomous vehicle for the customer who is performing the checkout functions. While this is discussed in more detail in FIGS. 3 and 4, the checkout application can identify a customer (e.g., using facial recognition or as part of a customer loyalty program) and determine when the customer reaches the trigger stage of the checkout process. For example, the checkout application 125 may summon the vehicle when the customer finished scanning her items, when the user selects a payment option, or after a user has paid, etc. The checkout application 125 can summon the customer’s vehicle automatically, without customer input. However, the checkout application 125 may display a prompt on the POS system 100 indicating that it has summoned the customer’s vehicle. This can give the customer a chance to cancel the summons, if desired.

The memory 120 also stores a vehicle summoner 130 (e.g., a software application) for receiving a prompt from the checkout application 125 when time to summon the customer’s vehicle. The vehicle summoner 130 can serve as an interface between the POS system 100 and a communication network that communicates with the autonomous vehicle. The vehicle summoner 130 can store login information (e.g., security tokens) so that the vehicle summoner 130 has permission to use (or access) an autonomous vehicle summoning system on behalf of the customer.

In one embodiment, the customer registers with the vehicle summoner 130 before the summoner 130 can summon the customer’s vehicle. For example, auto-summoning the customer’s vehicle may be part of a retailer’s loyalty program (and offered to members). A customer can use the loyalty program to provide login information, or otherwise give permission, for the vehicle summoner 130 to send instructions to the autonomous vehicle summoning system.

In another embodiment, auto-summoning the customer’s vehicle may be part of a credit card program so that when the customer pays with that credit card, the credit card company provides access or permission for the vehicle summoner to access the autonomous vehicle summoning system. However, the embodiments herein are not limited to any particular technique for registering a customer so the POS system 100 can access and use the autonomous vehicle summoning system that controls the customer’s autonomous vehicle.

The display 140 can display information to the customer such as the identity of the item detected by the POS applications 125, a list of items already purchased, cost of the items, etc. The display 140 could be a touch screen for user interaction, or may not have touch capabilities. If the display 140 is a touch screen, it can serve as an input/output (IO) device for receiving customer input.

Although not shown, the POS system 100 can also include one or more cameras 135 arranged to view an item-receiving area 155 on which the shopper places items for purchase. For example, a camera may disposed in a downward direction. Moreover, to improve the ability to successful identify an item, cameras may also be disposed on the sides of the POS system 100.

The item-receiving area 155 defines an area where a customer can place an item for purchase so it can be identified by, for example, scanning a barcode, reading an RFID tag, capturing images of the item and using an the item recognition application, and the like. In one embodiment, the item-receiving area 155 can include a weight sensor (e.g., a scale) or pressure sensors to identify an outline of the item, but this is not a requirement.

The payment system 170 can include a credit card reader, chip reader, near field communication (NFC) reader, coin/currency machine, and the like.

In one embodiment, the POS system 100 is a self-service POS system (or self-service kiosk). However, in other embodiments the POS system 100 may be a cashier operated POS system.

FIG. 1B illustrates a mobile device 175 (e.g., a smartphone, tablet, etc.) that executes the checkout application 125. In this embodiment, the checkout application 125 can be a mobile shopping app. For example, the mobile device 175 can include a camera with which the user can capture images of the item they wish to purchase. In one example, the user can capture an image of a barcode on the item or use object recognition. The checkout application 125 can decode the barcode to identify the item being purchased by the user. For example, the user may walk through a store and use the mobile device 175 to capture images of items they wish to purchase, which the checkout application 125 adds to a virtual shopping cart. Thus, the checkout application 125 permits the user to purchase items without having to use a checkout kiosk at the store.

While the embodiments herein describe using a camera to enable the checkout application 125 to add items to the virtual cart, other technologies could be used such as RFID. Further, a machine learning algorithm could be used by the checkout application 125 to identify the items rather than relying on a barcode, which can be used when purchasing items which may not have barcodes (e.g., fresh fruit or vegetables).

As discussed in FIG. 1A, the checkout application 125 in FIG. 1B can identify the stage that the customer is in in the checkout process, such as arriving at a store, logging into checkout application 125 on the mobile device 175, scanning items, selecting a payment option, completing payment, etc. One of these stages can be selected as the trigger stage which, when reached by the customer, triggers the checkout application 125 to summon the customer’s vehicle to a designated area (e.g., a lane near the store’s exit, special parking spots, etc.). The checkout application 125 can then instruct the vehicle summoner 130 to interface with the autonomous vehicle summoning system in order to move the care to the designated area.

In this manner, FIGS. 1A and 1B illustrate that a checkout application 125 executing on a POS system (whether a self-service kiosk or a cashier operated POS) or customer’s personal mobile device to auto-summon an autonomous vehicle during a checkout process.

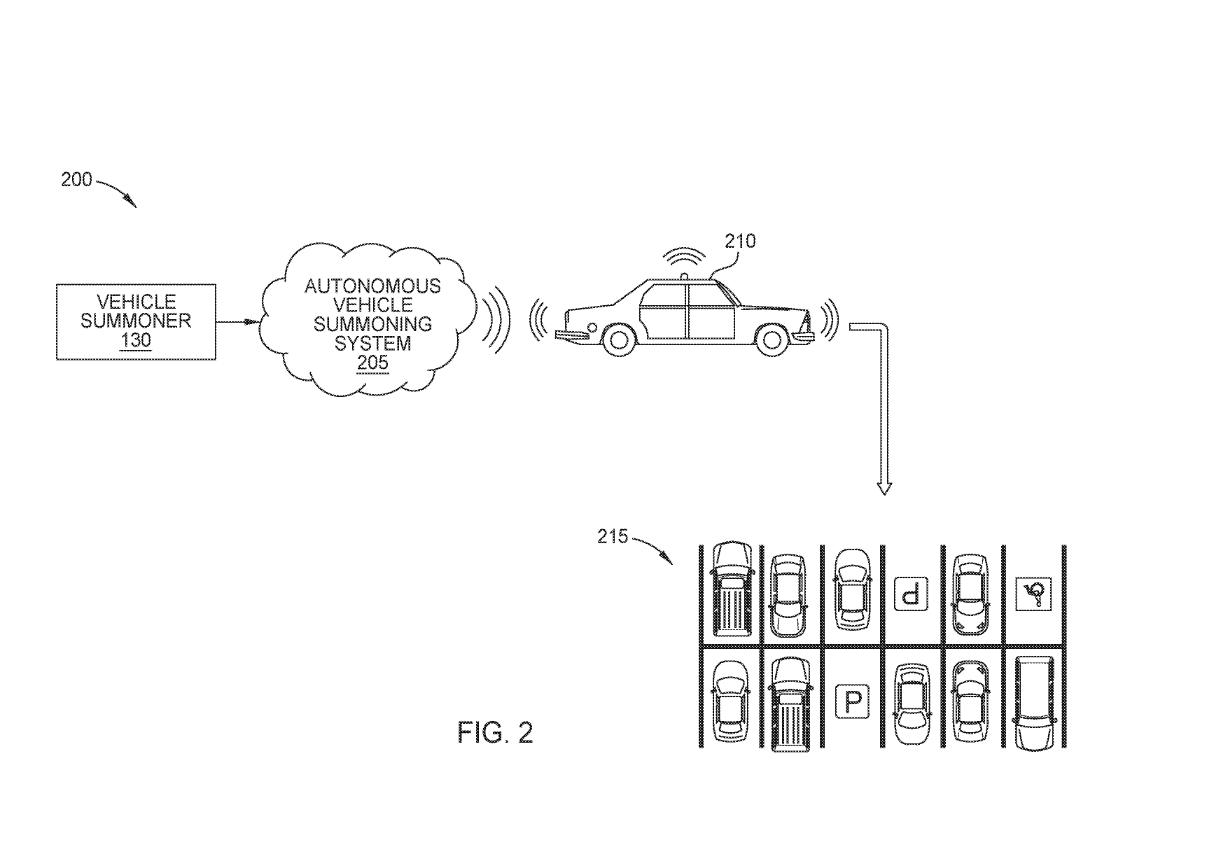

FIG. 2 illustrates a system 200 for auto-summoning a customer’s autonomous vehicle, according to embodiments described herein. The system 200 includes the vehicle summoner 130, an autonomous vehicle summoning system 205, an autonomous vehicle 210, and an area 215 designated for autonomous vehicles to pick up exiting customers from a retail store.

The system 200 assumes that a checkout application (e.g., the checkout application 125 in FIGS. 1A and 1B) has reached a trigger stage and instructed the vehicle summoner 130 to summon a customer’s vehicle. In response, the vehicle summoner 130 sends an instruction or request to the autonomous vehicle summoning system 205. This system 205 can operate, e.g., in the cloud or in a data center. The vehicle summoner 130 may use a wired network and/or wireless networks to communicate with the autonomous vehicle summoning system 205.

In one embodiment, the vehicle summoner 130 may provide login information or security information to the autonomous vehicle summoning system 205 to prove the vehicle summoner 130 is authorized to control the vehicle 210 on behalf of the customer.

The vehicle summoner 130 can also provide a location where the autonomous vehicle summoning system 205 should direct the vehicle 210. As mentioned above, the location may be a general area, a pick up lane or line in front of the store, a parking lot, or a particular parking spot.

The autonomous vehicle summoning system 205 can communicate wirelessly with the vehicle 210 (e.g., using a cell network) to instruct the vehicle 210 to the designated area 215. The autonomous vehicle summoning system 205 can provide a GPS location to the vehicle 210 or could provide a general location to the vehicle 210 and it is up to the on-board navigation system in the vehicle 210 to identify a place to park. For example, the vehicle summoner 130 may instruct the vehicle 210 to park in a parking lot, in any available spot. The autonomous vehicle summoning system 205 may guide the vehicle 210 to the parking lot but it may be up to the vehicle 210 to identify an open spot in the lot.

In one embodiment, the designated area 215 may include guides that help the vehicle 210 identify an appropriate spot. These guides could be wireless beacons such as Bluetooth beacons, RFIDs, and the like. The vehicle 210 could receive wireless communications from the beacons in order to identify the spot. In another example, the guides could be a QR code or a number of a plaque or sign at the spot. Because autonomous vehicles 210 can have cameras, it can use the images to detect the appropriate spot.

The POS system or the customer’s mobile device can inform the customer where the vehicle 210 is (or will be) so the customer can find the vehicle 210. For example, after completing the checkout process, the POS system or mobile device can display a message that says “You can meet your vehicle at parking spot B” or “Your car will be waiting for you in the pickup lane to the right of the exit.”

FIG. 3 is a flowchart of a method 300 for determining when to summon an autonomous vehicle for a customer performing a checkout process, according to embodiments described herein. At block 301, the checkout application identifies a customer using a checkout application in a retail store to perform a checkout process. For example, the checkout application may identify the customer when the user scans a loyalty card, enters a loyalty number, or enters in a phone number that is tied to the loyalty number.

In another embodiment, the user is identified using facial recognition. For example, the POS may include a camera that views the customer at the POS system. This also can be used to identify the customer as a member of the retailer’s loyalty program.

In another embodiment, the customer can be identified by her method of payment. For example, if the customer pays by credit card, the checkout application can use this information (if authorized by the customer and the credit card company) to identify the customer.

In another embodiment, if the checkout application is used on a customer’s personal mobile device rather than a POS system, the checkout application can store the user identification information so the customer is identified when she opens the checkout application on her mobile device.

At block 305, the checkout application determines, based on identifying the customer, whether it is authorized to summon the customer’s autonomous vehicle. For example, the customer may first have to provide login information or otherwise authorize the checkout application and the vehicle summoner to use an autonomous vehicle summoning system (e.g., the autonomous vehicle summoning system 205 in FIG. 2).

As mentioned above, auto-summoning the vehicle may be a part of a retailer’s loyalty program which the customer can register for when signing up for the loyalty program, which authorizes the checkout application to summon the vehicle. In another example, the credit card company could also inform the checkout application if it is authorized to auto-summon the customer’s vehicle.

At block 310, the checkout application determines whether the user has reached a trigger stage in a checkout process. In one embodiment, the checkout application identifies the stage that the customer is in in the checkout process, such as arriving at a POS system, logging into the checkout application, scanning items, selecting a payment option, completing payment, loading purchased items in a cart/basket, etc. One of these stages can be selected as the trigger stage which, when reached by the customer, triggers the checkout application to summon the customer’s vehicle to a designated area. The particular stage used to trigger auto-summoning the vehicle can vary depending on the distance from the user’s current location to the designated area, the amount of items the user purchased (which can affect how fast the customer or a cashier can load items into a cart or basket), the historical time it takes the customer to checkout, a queue at the exit of the store, and the like.

For example, the trigger stage for a particular POS system may be set, regardless of the customer who uses the POS system. For example, the trigger stage may be selected based on the distance from the POS system to the designated area. In another embodiment, the trigger stage for a particular POS may be dynamic depending on the customer. For example, the checkout application may monitor historical data to determine how long a customer takes to checkout (after the customer is identified at block 305) and select the trigger stage based on that time period. Or the checkout application may use computer vision to identify the number of items in the customer’s cart or basket and select a trigger stage based on that number (where if the customer has a lot of items, it might choose a later stage in the checkout process than if the customer has a few items).

If the customer has not yet reached the trigger stage, the method 300 proceeds to block 315 where the checkout application continues the checkout process until reaching the trigger stage.

Once the trigger stage is reached, the method 300 proceeds to block 315 where the checkout application determines whether the items purchased satisfy a summoning threshold. For example, the checkout application can determine how many items were purchased by the customer once he has indicated he is ready to checkout (this assumes that the trigger stage is after this part of the checkout process). Or, before the user has begun to scan items, the checkout application can use images captured by cameras in the POS system to estimate the number of items the customer has in her cart/basket. Regardless, the number of items could be compared to a first summoning threshold to determine whether the customer has sufficient items to warrant summoning her vehicle.

In another example, a second summoning threshold could evaluate the weight of the items being purchased. Even if the customer did not satisfy the first summoning threshold, the items may satisfy the second summoning threshold based on weight. Or a third summoning threshold could evaluate the volume or bulkiness of the items (e.g., pillows or a comforter which may be light but bulky). Even if the items did not satisfy the first and second summoning thresholds, they could satisfy this third threshold.

In one embodiment, the summoning thresholds are user configurable. For example, the customer could tell the checkout application the thresholds so the application summons the vehicle according to the customer’s preferences. In one embodiment, the customer may instruct the checkout application to auto-summon her vehicle regardless of the number, weight, or size of the purchased items (i.e., proceed directly from block 310 to block 325).

If none of the summoning thresholds are satisfied, the method 300 proceeds to block 320 where the checkout application completes the checkout process without summoning the customer’s vehicle.

However, if one of the summoning thresholds is satisfied, the method 300 proceeds to block 325 where the vehicle summoner summons the autonomous vehicle to a designated area near the store’s exit. For example, the checkout application can provide instructions to the vehicle summoner to summon the autonomous vehicle when the trigger stage has been reached and the items satisfy the summoning threshold. The vehicle summoner can then summon the autonomous vehicle as discussed in FIG. 3. The checkout application would then be free to complete the checkout process while the vehicle summoner interfaces with an autonomous vehicle summoning system.

In one embodiment, the method 300 is also used with the aid of robotic shopping carts. For example, the customer (or a bagger) could load the customer’s items into a robotic shopping cart which can autonomously move the items for the customer. Because the vehicle summoner knows where the customer’s autonomous vehicle is (or will be) located in the designated area, the vehicle summoner can provide that location the robotic shopping cart or guide the robotic shopping cart to that location. In this manner, the vehicle summoner can direct the customer’s vehicle and a robotic shopping cart to the same location. This avoids the robotic shopping cart from having to follow the customer or otherwise obtain the location where the customer parked her vehicle.

FIG. 4 is a flowchart of a method 400 for managing traffic flow when summoning an autonomous vehicle for a customer performing a checkout process, according to embodiments described herein. The method 400 can be performed in parallel or in overlapping time periods with the method 300 in FIG. 3.

At block 405, a traffic monitoring application for the retailer monitors traffic in the designated area for the retail store (e.g., the designated area 215). For example, the traffic monitoring application may have access to cameras that capture views of the designated area to determine its occupancy level. If the designated area is a parking lot, the cameras could capture the number of unoccupied spots. If the designated area is a pick up lane, the traffic monitoring application could determine how many cars are parked in the lane versus its total occupancy.

In another example, the traffic monitoring application receives input from sensors (e.g., parking spot sensors) that inform the traffic monitoring application how many parking spots are unoccupied.

At block 410, the retailer determines whether there is sufficient space to summon a customer’s vehicle. For example, when performing method 300 to determine a customer’s car should be auto-summoned, the checkout application may perform block 410 to determine whether there is sufficient space for the customer’s vehicle if it were summoned. For example, the checkout application may have access to a memory location that stores the current occupancy of the designated area, or the checkout application may query the traffic monitoring application to determine the current occupancy of the designated area.

If the checkout application determines there is sufficient space, then the method 400 proceeds to block 415 where it summons the vehicle. This may be performed using any of the techniques discussed in block 325 of the method 300.

However, if there is not sufficient space (e.g., the designated area is full), the method 400 proceeds to block 420 where the checkout application determines whether the customer should be given priority. For example, the traffic monitoring application may maintain a queue of customers who are currently waiting for a spot in the designated area to free up so their vehicles can be moved into the designated area. The customers may normally be moved into, and out of, the queue on a first-in-first-out (FIFO) basis by the checkout applications executing on the POS systems (or customers’ mobile devices) in the store.

However, the retailer may want some priority customers to skip this queue, e.g., jump to the front of the queue so their vehicle will be summoned next. For example, customers who are handicapped, have small children with them, and the like may be designated as priority customers. The checkout application may determine whether a customer is a priority customer based on a member profile in the retailer’s loyalty program or by monitoring cameras at the POS systems. For example, a customer-facing camera in the POS system may determine the customer is using a mobility scooter, has a cane, has a baby carrier in their cart, and thus, are priority customers.

If the checkout application determines the customer is a priority customer, at block 420 the checkout application permits the customer to move up in the queue (e.g., jump to the front of the queue, or jump half way up the queue). Once the customer reaches the front of the queue, the method 400 can proceed to block 415 where the vehicle summoner summons the customer’s vehicle.

If the customer is not a priority customer, the method 400 instead proceeds to block 425 where the POS system or mobile device executing the checkout application displays an estimated wait time to the customer. This wait time may be calculated by the traffic monitoring application based on, for example, a rate at which the vehicles are leaving the designated area, historical data, monitoring images of the designated area to determine how many customers are entering their vehicles and preparing to leave, and the like.

Moreover, in one embodiment, the checkout application can use the estimated queue wait time to determine the trigger stage. The checkout application can constantly query the traffic monitoring application to determine the queue wait time, and if it is large, use a trigger stage that is earlier in the checkout process (e.g., when the customer scans her first item). If the queue time is small, the checkout application may use a later stage (e.g., after starting the payment process).

At block 430, the checkout application determines whether the customer confirms the vehicle should be summoned. The customer may prefer to walk to their vehicle rather than wait for it to be summoned. The customer can provide their input using an IO device in the POS system or mobile device. If the customer would rather not wait in the queue, the method 400 proceeds to block 435 where the checkout application does not summon the customer’s vehicle.

However, if the customer decides the wait time is acceptable, the method 400 proceeds to block 440 where the vehicle summoner waits until there is a spot available (as determined by the traffic monitoring application) and then summons the vehicle at block 415.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference was made to embodiments presented in this disclosure. However, the scope of the present disclosure is not limited to the described embodiments. Instead, any combination of the features and elements descried herein, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages described herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the vehicle summoner) or related data available in the cloud. For example, the vehicle summoner could execute on a computing system in the cloud and summon a customer’s autonomous vehicle when instructed by the checkout application 125. In such a case, the vehicle summoner could call the vehicle using information and stored at a storage location in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method comprising:
receiving a customer identity associated with a customer using a checkout application in a retail store to perform a checkout process;
determining, based on the customer identity, that checkout application is authorized to summon an autonomous vehicle associated with the customer;
determining that the checkout application executes a trigger stage in the checkout process; and
responsive to determining that the checkout application executed the trigger stage in the checkout process, providing an instruction that summons the autonomous vehicle to a designated area.

2. The method of claim 1, wherein the autonomous vehicle is summoned automatically without customer input.

3. The method of claim 1, further comprising, before providing the instruction:
identifying items being purchased by the customer in the checkout process; and
determining whether the items satisfy a summoning threshold, wherein the instruction is provided to summon the autonomous vehicle after determining the items satisfy the summoning threshold.

4. The method of claim 3, wherein the summon threshold defines at least one of: a minimum number of items needed before the autonomous vehicle is summoned, a minimum weight of the items needed before the autonomous vehicle is summoned, or a minimum bulkiness of the item before the autonomous vehicle is summoned.

5. The method of claim 1, further comprising, before providing the instruction:
monitoring vehicular traffic in the designated area; and
determining available space in the designated area, wherein the instruction is provided to summon the autonomous vehicle after determining there is sufficient space in the designated area for the autonomous vehicle.

6. The method of claim 5, further comprising, before determining there is sufficient space in the designated area for the autonomous vehicle:
determining there is not sufficient space in the designated area for the autonomous vehicle, wherein there is a queue of customers waiting for available space in the designated area so their associated autonomous vehicles can be summoned;
determining the customer is a priority customer based on capturing images of the customer using a camera in a point-of-sale (POS) system used to perform the checkout process; and
moving the customer up in the queue.

7. The method of claim 5, further comprising, before determining there is sufficient space in the designated area for the autonomous vehicle:
determining there is not sufficient space in the designated area for the autonomous vehicle;
displaying an estimated wait time before space will be available for the autonomous vehicle in the designated area; and
receiving, after the wait time is displayed, a confirmation from the customer indicating if the customer wants the autonomous vehicle to be summoned.

8. The method of claim 1, wherein the checkout application is executed on a POS system in the retail store.

9. The method of claim 1, wherein the checkout application is executed on a customer’s mobile device.

10. A system, comprising:
one or more memories; and
one or more processors communicatively coupled to the one or more memories, the one or more processors configured to, individually or collectively to perform operations, the operations comprising:
receiving a customer identity associated with a customer using a checkout application in a retail store to perform a checkout process;
determining, based on the customer identity, that checkout application is authorized to summon an autonomous vehicle associated with the customer;
determining that the checkout application executes a trigger stage in the checkout process; and
responsive to determining that the checkout application executed the trigger stage in the checkout process, providing an instruction that summons the autonomous vehicle to a designated area.

11. The system of claim 10, wherein the autonomous vehicle is summoned automatically without customer input.

12. The system of claim 10, wherein the operations further comprises, before providing the instruction:
identifying items being purchased by the customer in the checkout process; and
determining whether the items satisfy a summoning threshold, wherein the instruction is provided to summon the autonomous vehicle after determining the items satisfy the summoning threshold,
wherein the summon threshold defines at least one of: a minimum number of items needed before the autonomous vehicle is summoned, a minimum weight of the items needed before the autonomous vehicle is summoned, or a minimum bulkiness of the item before the autonomous vehicle is summoned.

13. The system of claim 10, wherein the operations further comprises, before providing the instruction:
monitoring vehicular traffic in the designated area; and
determining available space in the designated area, wherein the instruction is provided to summon the autonomous vehicle after determining there is sufficient space in the designated area for the autonomous vehicle.

14. The system of claim 13, wherein the operations further comprises, before determining there is sufficient space in the designated area for the autonomous vehicle:
determining there is not sufficient space in the designated area for the autonomous vehicle, wherein there is a queue of customers waiting for available space in the designated area so their associated autonomous vehicles can be summoned;
determining the customer is a priority customer based on capturing images of the customer using a camera in a point-of-sale (POS) system used to perform the checkout process; and
moving the customer up in the queue.

15. The system of claim 13, wherein the operations further comprises, before determining there is sufficient space in the designated area for the autonomous vehicle:
determining there is not sufficient space in the designated area for the autonomous vehicle;
displaying an estimated wait time before space will be available for the autonomous vehicle in the designated area; and
receiving, after the wait time is displayed, a confirmation from the customer indicating if the customer wants the autonomous vehicle to be summoned.

16. A computer readable storage medium having computer-readable program code embodied therewith, the computer-readable program code executable by one or more computer processors to perform operations, the operations comprising:
receiving a customer identity associated with a customer using a checkout application in a retail store to perform a checkout process;
determining, based on the customer identity, that checkout application is authorized to summon an autonomous vehicle associated with the customer;
determining that the checkout application executes a trigger stage in the checkout process; and
responsive to determining that the checkout application executed the trigger stage in the checkout process, providing an instruction that summons the autonomous vehicle to a designated area.

17. The computer readable storage medium of claim 16, wherein the autonomous vehicle is summoned automatically without customer input.

18. The computer readable storage medium of claim 16, wherein the operations further comprises, before providing the instruction:
identifying items being purchased by the customer in the checkout process; and
determining whether the items satisfy a summoning threshold, wherein the instruction is provided to summon the autonomous vehicle after determining the items satisfy the summoning threshold,
wherein the summon threshold defines at least one of: a minimum number of items needed before the autonomous vehicle is summoned, a minimum weight of the items needed before the autonomous vehicle is summoned, or a minimum bulkiness of the item before the autonomous vehicle is summoned.

19. The computer readable storage medium of claim 16, wherein the operations further comprises, before providing the instruction:
monitoring vehicular traffic in the designated area; and
determining available space in the designated area, wherein the instruction is provided to summon the autonomous vehicle after determining there is sufficient space in the designated area for the autonomous vehicle.

20. The computer readable storage medium of claim 19, wherein the operations further comprises, before determining there is sufficient space in the designated area for the autonomous vehicle:
determining there is not sufficient space in the designated area for the autonomous vehicle, wherein there is a queue of customers waiting for available space in the designated area so their associated autonomous vehicles can be summoned;
determining the customer is a priority customer based on capturing images of the customer using a camera in a point-of-sale (POS) system used to perform the checkout process; and
moving the customer up in the queue.
